(19) United States
(12) Patent Application Publication
(10) Pub. No.: US 2010/0285223 A1
(43) Pub. Date: Nov. 11, 2010

(54) Method for Manufacturing Lyocell Based Carbon Fiber and Lyocell Based Carbon Fabric

(76) Inventors: Jong Kyoo Park, Daejeon-si (KR); Jae Yeol Lee, Daejeon-si (KR); Yong Gu Won, Daejeon-si (KR); Dong Hwan Cho, Gyeongsangbuk-do (KR)

Correspondence Address: CAHN & SAMUELS LLP, 1100 17th STREET NW, SUITE 401, WASHINGTON, DC, 20036, US

(21) Appl. No.: 12/763,651

(22) Filed: Apr. 20, 2010

(30) Foreign Application Priority Data
May 8, 2009 (KR) 10-2009-0040089
Oct. 12, 2009 (KR) 10-2009-0096749

(51) Int. Cl. B05D 3/00

(52) U.S. Cl. 427/324

(57) ABSTRACT

Disclosed is a method for manufacturing Lyocell based carbon fiber or Lyocell based carbon fabric, and more specifically a method for manufacturing Lyocell based carbon fiber or Lyocell based carbon fabric through the process comprising stabilization, carbonization and graphitization, and a pretreatment step before the stabilization of treating Lyocell fiber or Lyocell fabric by immersing the fiber or the fabric in a solution comprising silicon-based polymer and an aqueous solution comprising flame resistant salt.

### TECHNICAL FIELD

The present invention relates to a method for manufacturing Lyocell based carbon fiber and Lyocell based carbon fabric. More specifically, the invention relates to a method for manufacturing Lyocell based carbon fiber and Lyocell based carbon fabric through the process which comprises the steps of stabilization, carbonization and graphitization, and a pretreatment step, before the step of stabilization, of treating the Lyocell fiber or Lyocell fabric by immersing the fiber or the fabric in a solution comprising silicon-based polymer and an aqueous solution comprising flame resistant salt.

### BACKGROUND ART

Generally, carbon fibers are classified into rayon fibers, polyacrylonitrile (PAN) fibers and pitch fibers depending on the type of the precursors used.

Rayon fibers, which have been produced from high-purity viscous rayon fibers by using CS₂ as a solvent, are losing market share due to the use of a regulated pollutant, CS₂, in the manufacturing process and the low economic efficiency compared to PAN fibers and pitch fibers.

Lyocell fiber has been developed by Akzo-Nobel in 1978, which employed a new manufacturing process free of environmental pollutants and hazardous substances. The Lyocell fiber is a spun fiber made chiefly from natural pulp composed mainly of cellulose, and N-methylmorpholine-N-oxide (NMMO) which is a solvent for dissolving the pulp, by wet-and-dry type spinning process. The material for Lyocell fiber is cellulose extracted from the wood pulp, which is environmentally friendly since it is completely bio-degradable and recyclable polymer. Also, the manufacturing process of Lyocell fiber does not produce any pollutants, which has been a serious problem of conventional manufacturing method of rayon fiber.

Lyocell fiber, despite the chemical properties as a cellulose-based fiber, shows improved mechanical and physical properties and is different from conventional cellulose-based fiber in microscopic structure such as the degree of crystallization and the orientation of the crystal. Notwithstanding all the advantages, Lyocell fiber was able to be produced in the form of spun yarn in early 1990 and commercially manufactured in a small scale as filament fiber in early 2000. In Korea, Hyosung Corporation and Kolon Industries, Inc. have large-scale facility for manufacturing Lyocell filament.

Generally, manufacturing process of carbon fiber includes three processes: stabilization, carbonization and graphitization. These processes are carried out using materials in the state of fiber or fabric, and the final temperature of carbonization or graphitization is determined based on the usage of the carbon fiber. The temperature of carbonization and graphitization greatly affects the thermal conductivity, insulating properties and elastic modulus of the final product.

Also, the internal structure and physical properties of the carbon fiber can be greatly affected by various factors applied in the stabilization and carbonization processes, such as the temperature of heat-treatment, heating rate, holding step, chemical treatment of fiber's surface, and atmospheric gas. The stabilization process is a heat-treatment process which is common in every manufacturing process of carbon fibers including PAN fibers and pitch fibers, and especially most important process in manufacturing rayon fibers. In stabilization process, in general, serious changes of chemical and physical properties are abruptly caused, which is aimed at generating stable chemical structure that can endure high temperature required in the followed carbonization process. Chemical pretreatment process is inevitable in order to improve the effect of the stabilization process, and thus the development of technologies for the pretreatment process in manufacturing carbon fibers is needed by the industry.

### SUMMARY OF THE INVENTION

In one embodiment, the strategic planning computer module includes at least one of The object of the present invention is to provide a method for manufacturing Lyocell based carbon fiber and Lyocell based carbon fabric, wherein the pretreatment step of treating Lyocell fiber or Lyocell fabric by immersing the fiber or the fabric in a solution comprising silicon-based polymer and an aqueous solution comprising flame resistant salt is carried out before the stabilization process in order to improve the effect of the stabilization process.

### DETAILED DESCRIPTION OF THE INVENTION

The method for manufacturing Lyocell based carbon fiber or Lyocell based carbon fabric according to the present invention comprises a pretreatment process of treating Lyocell fiber or Lyocell fabric by immersing the fiber or the fabric in a solution comprising silicon-based polymer and an aqueous solution comprising flame resistant salt, and the processes of stabilization, carbonization and graphitization.

In the pretreatment process of the present invention, Lyocell fiber or Lyocell fabric is treated by immersing the fiber or the fabric in a solution comprising silicon-based polymer and an aqueous solution comprising flame resistant salt. The silicon-based polymer that can be used in the present invention includes polysiloxane (PS), polydimethylsiloxane (PDMS), room temperature vulcanizing (RTV) silicone, polymethyl phenyl siloxane (PMPS), polysilazane and the like, and the flame resistant salt includes ammonium phosphate ((NH₄)₃PO₄), sodium phosphate (Na₃PO₄), ammonium chloride (NH₄Cl) and the like.

In the solution comprising silicon-based polymer, a polar solvent can be used as a solvent. The examples of the polar solvents include acetone, perchloroethylene, tetrahydrofurane (THF), Methy Ethyl Ketone (MEK), ethyl alcohol, methyl alcohol and the like.

Concentration of the silicon-based polymer in the solution comprising silicon-based polymer used in the pretreatment process of the present invention is preferably 1-15% by weight. Concentration outside this preferred range is not preferable since stabilization effect is not exhibited when the concentration of the silicon-based polymer is less than 1% by weight, and brittleness as well as irregularities becomes greater when the concentration is higher than 15% by weight. Concentration of the flame resistant salt in the aqueous solution of flame resistant salt is preferably 3-20% by weight. Concentration outside this preferred range is not preferable since flame resistance does not show when the concentration of the flame resistant salt is less than 3% by weight, and supersaturation state is caused when the concentration is higher than 20% by weight.

Also, the immersion treatment is carried out by immersing the fiber or the fabric sequentially in a solution of silicon-based polymer and an aqueous solution of flame resistant salt preferably at the temperature between room temperature (about 25 degrees Celsius) and 80 degrees Celsius for within 1 hour, preferably for 10-60 minutes. Temperature outside the range is not preferable since the effect of stabilization diminishes when the temperature is lower than room temperature and the flexibility of the fiber decreases when the temperature is higher than 80 degrees Celsius. Also, when the immersion time is longer than 1 hour, cellulose can swell in the solution or the strength can be decreased. While the immersion treatments in the solution of silicon-based polymer and the aqueous solution of flame resistant salt can be carried out in any order, it is preferable to immerse in the solution of silicon-based polymer first and then in the aqueous solution of flame resistant salt later.

The stabilization process of the present invention is carried out in two steps. Heat treatment is carried out preferably at 100-250 degrees Celsius for 10-30 hours in the first step, and at 300-500 degrees Celsius for 10-100 hours in the second step. Treating in other range of temperature and time is not preferable. In the first step, the fiber is not sufficiently dried when the temperature is lower than 100 degrees Celsius, and the thermal decomposition of the fiber can occur when the temperature is higher than 250 degrees Celsius. Also, the flexibility of the fiber can diminish when the time is less than 10 hours, and the stabilization efficiency is decreased when the time is longer than 30 hours. In the second step, the effect of stabilization is not sufficient when the applied temperature is lower than 300 degrees Celsius, and the carbonization is more affected than the stabilization when the applied temperature is higher than 500 degrees Celsius. Also, the flexibility of the fiber can diminish when the applied time is less than 10 hours, and the stabilization efficiency is decreased when the applied time is longer than 100 hours.

In the carbonization process of the present invention, heat treatment is carried out preferably at 900-1700 degrees Celsius for 10-30 hours. Treating in other range of temperature and time is not preferable. The rate of carbonization becomes lower than 80% when the applied temperature is less than 900 degrees Celsius, and the effect of graphitization is more salient than the effect of carbonization and strength diminishes when the applied temperature is higher than 1700 degrees Celsius. Also, the carbonization is not sufficiently carried out when the applied time is less than 10 hours, and the carbonization yield becomes lower when the applied time is longer than 30 hours.

In the present invention, the graphitization process, which can control thermal conductivity, insulation property and thermal-resistance property, is carried out preferably by raising the temperature to the graphitization temperature of 2000-2800 degrees Celsius and maintaining at the temperature for a holding time of 0-10 hours. The degree of graphitization decreases when the temperature is less than 2000 degrees Celsius and the effect of graphitization per cost becomes lower when the temperature is greater than 2800 degrees Celsius. Zero residence time at the temperature 2000-2800 degrees Celsius means that the temperature is immediately cooled as soon as the temperature reaches the graphitization temperature, and 10 hour of the holding time means that the system is maintained at the graphitization temperature for 10 hours and then cooled. The holding time of more than 10 hours at the graphitization temperature is not preferable since a final carbonization yield diminishes.

The present invention will be described in detail with reference to the drawings.

The flow diagram of FIG. 1 illustrates one example of the manufacturing process of Lyocell based carbon fabric according to the present invention. In fabrication process (1), the raw material, Lyocell fiber, is fabricated into a fabric with plain, twill or satin weave structure. The fabricated fabric is washed with an organic solvent such as acetone in washing process (2), thereby removing impurities and alleviating residual stress. And the fabric is sequentially passed through an aqueous solution comprising silicon-based polymer and an aqueous solution comprising flame resistant salt, and is dried in pretreatment process (3). Then the fabric is converted to carbon fabric by heat-treating through the stabilization process (4), carbonization process (5) and graphitization process (6). Finally, the Lyocell based carbon fabric according to the present invention is manufactured by removing residual tar or impurities remained in the carbon fabric in washing process (7).

FIG. 2 illustrates one example of the cycle of stabilization process in the manufacturing process of Lyocell based carbon fiber or Lyocell based carbon fabric according to the present invention. In the stabilization process, which is carried out in two steps, a dehydrogenation reaction and a cyclization reaction mainly occur and the weight of the fiber or the fabric is reduced by 60-70% by weight. In the first step of the stabilization process, a heat treatment is carried out by raising temperature to 100-250 degrees Celsius with a heating rate of 10-30 degrees Celsius/hour, and in the second step, to 300-500 degrees Celsius with a slow heating rate of 2-10 degrees Celsius/hour, thereby producing a stabilized fabric.

FIG. 3 illustrates one example of the cycle of carbonization process in the manufacturing process of Lyocell based carbon fiber or Lyocell based carbon fabric according to the present invention. The carbonization process is carried out under inert atmosphere by raising the temperature to 900-1700 degrees Celsius with a heating rate of 30-100 degrees Celsius/hour, heat-treating at the temperature for 10-30 hours, and then cooling in the air.

FIG. 4 illustrates one example of the cycle of graphitization process in the manufacturing process of Lyocell based carbon fiber or Lyocell based carbon fabric according to the present invention. In the graphitization process, the carbon fiber or carbon fabric, which is treated by the carbonization process, undergoes heat-treatment under inert atmosphere in a conventional heat-treatment furnace by raising the temperature to 1000-1500 degrees Celsius with a heating rate of 100-200 degrees Celsius/hour and to 2000-2800 degrees Celsius with a heating rate of 50-100 degrees Celsius/hour, and then maintaining at temperature of 2000-2800 degrees Celsius for residence time of 0-10 hours.

### BRIEF DESCRIPTION OF DRAWINGS

FIG. 1 is a flow diagram illustrating one example of the manufacturing process of Lyocell based carbon fabric according to the present invention.

FIG. 2 illustrates one example of the cycle of stabilization process in the manufacturing process of Lyocell based carbon fiber or Lyocell based carbon fabric according to the present invention.

FIG. 3 illustrates one example of the cycle of carbonization process in the manufacturing process of Lyocell based carbon fiber or Lyocell based carbon fabric according to the present invention.

FIG. 4 illustrates one example of the cycle of graphitization process in the manufacturing process of Lyocell based carbon fiber or Lyocell based carbon fabric according to the present invention.

FIG. 5 is a photograph of the Lyocell based carbon fabric manufactured according to the method of the present invention.

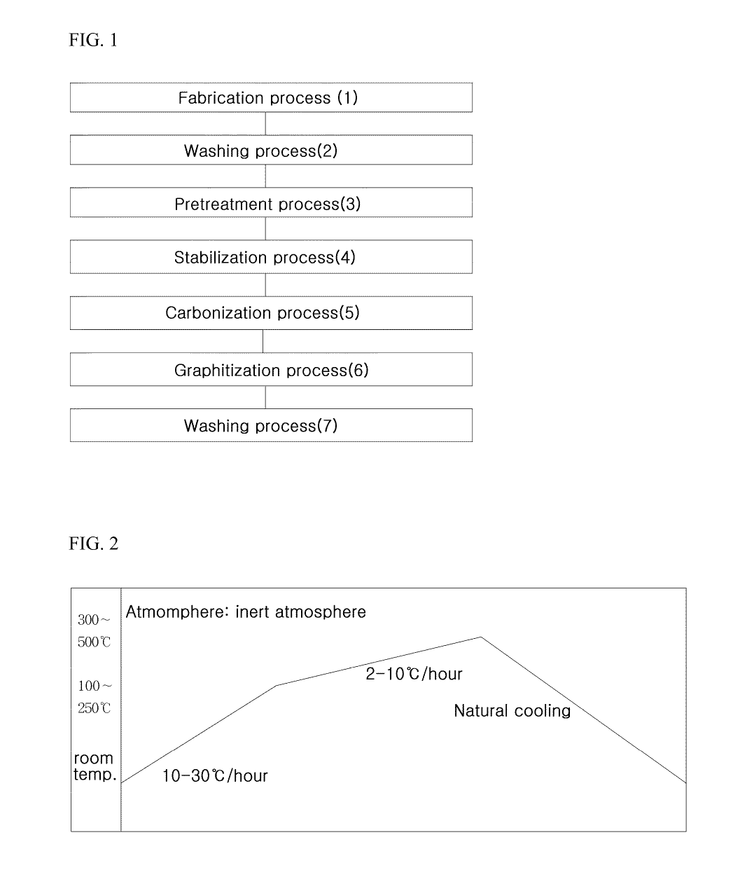

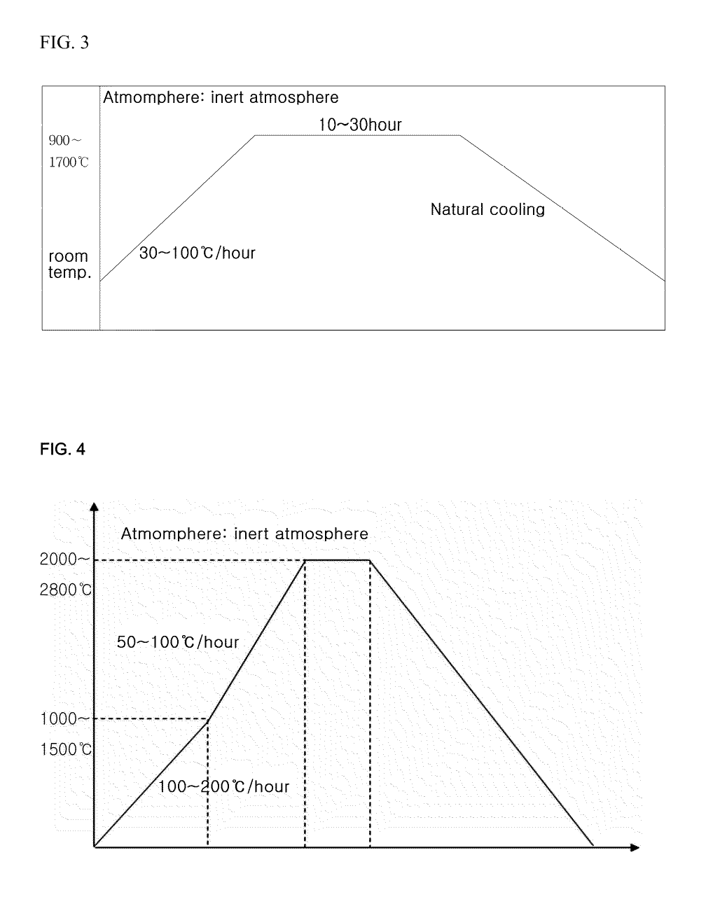

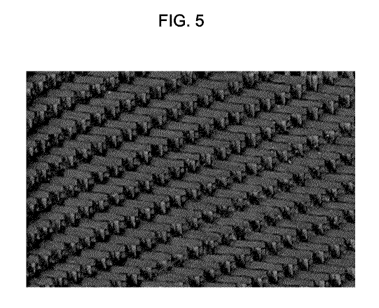

### BEST MODE OF THE INVENTION

The present invention will be described in more detail with reference to an example. The example of the invention, however, is just to illustrate the present invention and not intended to limit the scope of the invention to a specific example.

### Example

Lyocell fiber with fineness of 300 tex was fabricated by using a Rapier loom into a fabric of twill weave structure, immersed in the acetone with purity of 99.8% for about two hours, and washed. The washed fabric was immersed in the solution of 5% by weight of RTV silicon in perchloroethylene at 25 degrees Celsius for about 30 minutes, immersed in the aqueous solution of 15% by weight of ammonium chloride, a flame resistant salt, for about 30 minutes, and then dried at the temperature of 80 degrees Celsius. The stabilization of the pretreated fabric was carried out in a heat-furnace by raising temperature to 200 degrees Celsius with a heating rate of 30 degrees Celsius/hour, and in the second step, to 300 degrees Celsius with a slow heating rate of 2 degrees Celsius/hour. Then, the stabilized fabric is carbonized for 10 hours at 1700 degrees Celsius having been raised with heating rate of 50 degrees Celsius/hour, and then graphitized at 2000 degrees Celsius with a heating rate of 100 degrees Celsius/hour and a holding time of 1 hour. The characteristics of the carbon fabric manufactured and the carbon fiber extracted from the carbon fabric are shown in Table 1.

### Comparative Example

Lyocell based carbon fabric and Lyocell based carbon fiber were manufactured by using the same process as that of the Example except that the pretreatment step of immersing in the solution of silicon-based polymer and the aqueous solution of flame resistant salt was omitted in the process. The characteristics of the carbon fabric thus manufactured and the carbon fiber extracted from the carbon fabric are shown in Table 1.

TABLE 1

| | | Comparative |
|---|---|---|
| | Example | Example |
| Stabilization yield* (%) | 69 | 76 |

Carbon fiber

| | | |
|---|---|---|
| Tensile strength (MPa) | 404 | 265 |
| Carbonization yield (%) | 99 | 97 |

Carbon fabric

| Fabric strength in the warp | | 440 | 160 |
|---|---|---|---|
| direction (N/5 cm) | | | |
| Fabric areal density (g/m²) | | 272 | 290 |
| Flexibility | after stabilization | good | bad |
| | after graphitization | good | bad |

*Stabilization yield (%): Carbon content (%) after stabilization

### EFFECT OF THE INVENTION

By using the method of the present invention, which comprises, before the stabilization process, the pretreatment step of treating the Lyocell fiber or Lyocell fabric by sequentially immersing it in a solution of silicon-based polymer and an aqueous solution of flame resistant salt, the effect of the stabilization process can be improved.

What is claimed is:

1. A method for manufacturing Lyocell based carbon fiber or carbon fabric comprising the processes of stabilization, carbonization and graphitization of fiber or fabric, wherein Lyocell fiber or Lyocell fabric is used as the fiber or the fabric, and wherein a pretreatment step for treating the Lyocell fiber or the Lyocell fabric by immersing the Lyocell fiber or the Lyocell fabric in a solution comprising silicon-based polymer and an aqueous solution comprising flame resistant salt is carried out before the stabilization process.

2. The method of claim 1, wherein the silicon-based polymer is polysiloxane, polydimethylsiloxane, room temperature vulcanizing (RTV) silicone, polymethyl phenyl siloxane, or polysilazane.

3. The method of claim 1, wherein a solvent in the solution comprising silicon-based polymer is acetone, perchloroethylene, tetrahydrofurane, Methy Ethyl Ketone, ethyl alcohol, or methyl alcohol.

4. The method of claim 1, wherein the flame resistant salt is ammonium phosphate ((NH₄)₃PO₄), sodium phosphate (Na₃PO₄), or ammonium chloride (NH₄Cl).

5. The method of claim 1, wherein the stabilization process is carried out in two steps of heat treatment, the first step at the temperature of 100-250 degrees Celsius and the second step at the temperature of 300-500 degrees Celsius.

6. The method of claim 1, wherein the carbonization process is carried out by heat-treatment at the temperature of 900-1700 degrees Celsius for 10-30 hours.

7. The method for manufacturing carbon fiber or carbon fabric of claim 1, wherein the graphitization process is carried out by raising temperature up to 2000-2800 degrees Celsius, and then maintaining the temperature for the holding time of 0-10 hours.
